(19) United States
(12) Patent Application Publication
(10) Pub. No.: US 2015/0232348 A1
(43) Pub. Date: Aug. 20, 2015

(54) Water desalination and brine volume reduction process

(71) Applicant: Aqueous Jepson Technologies, LLC, Anchorage, AK (US)

(72) Inventor: William Paul Jepson, St. Augustine, FL (US)

(21) Appl. No.: 14/331,010

(22) Filed: Jul. 14, 2014

Related U.S. Application Data
(60) Provisional application No. 61/942,446, filed on Feb. 20, 2014.

(51) Int. Cl. C02F 1/04; B01D 3/06

(52) U.S. Cl. CPC C02F 1/04; B01D 3/06; C02F 2103/08

(57) ABSTRACT

The present invention is an improved thermal evaporation process capable of economically producing fresh water from a high saline water. The process employs the use of a multiphase pump with a compressor for injection of hot air into a brine stream. A series of mixers, separators and condensers separate the brine steam into a concentrated brine, a vapor brine and condensate. A portion of the concentrated brine is discharged and the remainder recycled to obtain conversion efficiencies approaching 80 percent.

### PRIORITY CLAIM

In accordance with 37 CFR 1.76, a claim of priority is included in an Application Data Sheet filed concurrently herewith. Accordingly, the present invention claims priority to U.S. Provisional Patent Application 61/942,446, entitled “Water Desalination and Brine Volume Reduction Process”, filed Feb. 20, 2014, the contents of which are incorporated herein by reference.

### FIELD OF THE INVENTION

The present invention relates generally to water treatment methods and in particular to an improved water desalination and brine volume reduction process.

### BACKGROUND OF THE INVENTION

Water covers two thirds of the earth, unfortunately most of the water is highly saline (seawater) and is unsuitable for human needs unless treated. Brackish water has a saline content much smaller than seawater but it also remains unsuitable for human needs unless treated. Fresh water, or water suitable for human consumption is mainly found on the two poles of the earth and in mountain glaciers leaving the accessible freshwater to be less than five percent of the available water. With the increase in populations, the demand for the freshwater is at a premium and in many instances even the freshwater must be purified to reach potable standards before human consumption.

The most abundant water on earth is seawater and most any process that is capable of treating seawater is also capable of treating brackish or non-potable water for purposes of making potable. The less saline the source water the more efficient a water treatment system may operate. Further, less contaminated water requires less pretreatment.

Currently, desalination techniques adopted worldwide are thermal and membrane methods. Well known water desalination methods include electrodialysis, distillation and reverse osmosis.

An electrodialysis system includes a positively charged anode, a negatively charged cathode, and alternating concentrating compartments and diluting compartments interposed between the anode and cathode. The electrical field established between the electrodes is understood to cause negatively charged anions to diffuse towards the anode and positively charged cations to diffuse towards the cathode. The concentrating compartments and diluting compartments are separated by compartment-separation ion-exchange membranes. An anion-exchange membrane bounds a diluting compartment on the side closer to the anode and allows anions to pass through while restraining the passage of cations. A cation-exchange membrane bounds a diluting compartment on the side closer to the cathode and allows cations to pass. Direct electrical current is made to flow between the anode and the cathode to remove ions from the diluting compartments and concentrate ions in the concentrating compartments. A diluting feed stream of water can be continuously provided to the diluting compartments and a concentrating feed stream can be continuously provided to the concentrating compartments.

A distillation system includes the heating of water in an evaporator up to a saturation temperature; the steam formed is extracted and condensed in a cooled condenser. When there is complete evaporation, those substances which cannot be evaporated remain in the evaporator as a solid residue. Multi-stage flash distillation comprises a plurality of flash stages, typically between 15 and 30. Heated water enters the first flash stage at its highest temperature, the solution flashes down in each consecutive flash stage to a lower temperature compared to the temperature of the solution in the previous flash stage, releasing water vapor which is condensed on a tube bundle and collected as distillate. The salt concentration of the solution is increasing toward the last flash stage. A coolant enters with its lowest temperature into the tube bundle(s) at the last flash stage and its temperature increases in each flash stage relative to its temperature in the previous flash stage as vapor is condensing on the tube bundles. The coolant discharging from the tube bundle(s) of the first flash stage is further heated in a separate heat exchanger, commonly described as the heat input section or brine heater, by an external heat source to a top temperature. The coolant is than used as the solution, also described as flashing brine, fed into the first flash stage. The most common design concept for multi stage flash desalination plants is the “brine re-circulation” system, in which the evaporator comprises a heat recovery section and a heat rejection section. The source of the heat for the evaporation process is high temperature steam (150 to 230° F.) Multi-stage systems operate at a slight vacuum which allows boiling saline water to occur at lower temperatures (150 to 180° F.)

A reverse osmosis system is designed to force water through a semi-permeable membrane under pressure. A reverse osmosis membrane only allows water molecules to pass and holds back most of the salt molecules. The process of desalination by reverse osmosis requires high pressure pumps to feed water through a vessel containing the membranes under a gauge pressure higher than the osmotic pressure of the raw water. For instance, water having total dissolved solids less than 1500 ppm may operate at low pressures while water having total dissolved solids greater than 30,000 ppm (seawater) requires a tenfold operating pressure. The permeate collected from the opposite side of the membrane and concentrated brine is removed from the feed side. Operational costs of reverse osmosis are high due to the cost of power consumption and expenses for pretreatment. Raw water used as a source for desalination by reverse osmosis may include suspended particles, organic and mineral, which must be treated before the membrane interface.

Pervaporation is a known separation process where fluid to be purified is conducted along the primary side of a membrane to the secondary side of which the components permeating the membrane are transferred in the vapor stage and transported away by a carrier gas. In this process, a high degree of selectivity is achieved in the separation of dissolved components. The substances which do not permeate the membrane remain in the residue fraction on the primary side of the membrane and cannot be separated from it without additional measures.

Other proposed water desalination methods include: U.S. Pat. No. 7,160,469 which describes a system and method for desalination of water, based on borderline fast fluctuation between liquid to gaseous state and back, by using centrifugal forces to make water droplets fly at a high speed, so that they evaporate for a split second, the salt is separated, and they condense again. That invention tries to make the process energy-efficient by enabling the use of lower speeds and smaller droplet sizes.

U.S. Pat. No. 4,767,527 discloses a process in which water to be cleaned is finely divided into a current of entrainment gas and evaporated. The water vapor formed is superheated, so that the impurities occur as a solid residue and can be collected. The heat of the purified and compressed mixture of entrainment gas and water vapor is used to superheat the water vapor in the current of entrainment gas. A separation between water and the substances contaminating it which cannot be evaporated is accomplished by introducing the water into a current of inert entrainment gas and by heating the mixture of entrainment gas and water vapor, before the separation of the solid particles, in the heat exchange with the purified and compressed mixture of entrainment gas and water vapor by cooling it to below the saturation or dew point temperature.

U.S. Pat. No. 2,921,004 discloses a method and apparatus for purifying sea or other water sources using a process where the water is heated to below its vaporization temperature and is passed to a zone of reduce pressure wherein it is subjected to flash evaporation.

U.S. Pat. No. 3,320,137 discloses a water purification method based upon flash evaporation by use of multiple stage evaporators to facilitate evaporation procedures leading to the purification technique.

U.S. Pat. No. 3,388,045 discloses an invention that relates to a distillation apparatus and method wherein the concentrations of the liquid to be distilled are maintained at or near the lowest point in the areas of highest temperature of the system.

U.S. Pat. No. 3,933,600 discloses a desalination system by vaporizing a part thereof by direct contact with a flame within a closed vessel, e.g., by introducing the water as a spray into a closed vessel onto the flame, removing a gaseous mixture of vaporized water and combustion products, and condensing the water in the mixture within a condenser, while withdrawing unvaporized residual water, enriched in salt, from the bottom of the vessel at a rate to maintain a pool thereof in the vessel.

U.S. Pat. No. 5,227,027 discloses a water purification system and process having a water pre-heating device positioned within the feed water to heat the feed water to approximately 150 degrees Fahrenheit to facilitate operation of a water evaporator device which vaporizes the water by boiling thereof. Contaminants are removed from this pure water vapor which is at approximately 215 degrees Fahrenheit. The water vapor is passed to a water condenser to provide high purity water at approximately 180 degrees Fahrenheit. The heat pump system provides for refrigerant condensing at approximately 225 degrees Fahrenheit to facilitate boiling of the water in the adjacent water evaporator and includes refrigerant vaporization adjacent the water condenser to facilitate absorbing and reclaiming of the latent heat of the distillate.

U.S. Pat. No. 6,635,149 discloses a water purification system and method for residential or commercial application having a first support structure coupled to a water supply having a first heat source of sufficient magnitude to change the water into steam, thus abandoning any insoluble material dispersed within the liquid. The steam is further heated in a second support structure to form a substantially gaseous vapor and exposed to a second heat source of sufficient magnitude to super-heat the vapor. The super-heated vapor is then allowed to condense to form potable water.

U.S. Pat. Nos. 7,163,636 and 8,080,166 disclose a multi-phase separation system utilized to remove contaminants from fluids includes a pre-filtering module for filtering a contaminated fluid to provide a filtered contaminated fluid. A condenser module receives the filtered contaminated fluid and a contaminated gas phase for condensing the contaminated gas phase to a contaminated liquid. A phase reaction chamber converts the filtered contaminated fluid to a contaminated mist wherein the mist is subjected to a low energy, high vacuum environment for providing a first change of phase by separating into a contaminated gas phase and a liquid mist phase. The contaminated gas phase is carried out of the phase reaction chamber by a carrier air. A vacuum pump provides the low energy, high vacuum environment in the phase reaction chamber and delivers the contaminated gas phase to the condenser module for condensation providing a second change of phase.

U.S. Publication No. 2011/0108407 discloses a method and apparatus for the desalination of water. The apparatus includes a pump, such as a progressive cavity pump, an initial gas/liquid separator such as a gravity separator, a liquid entrainment section such as a serpentine coil, a final in-line gas/liquid separator to separate the moisture-laden air stream from the brine, and a condenser to condense the moisture in the air stream to produce clean water.

W.O. Publication No. 2010/143856 discloses a seawater desalination apparatus, comprising a heater for heating seawater and a condenser for transferring the heat of the water vapor generated from the heated seawater to the seawater to be injected into the heater, wherein a gaseous heat source is brought into direct contact with the seawater which is a liquid object to be heated so that direct heat exchange is performed between the heat source and the seawater in the heater. Consequently, direct combustion gas or high-temperature gas such as water vapor or the like introduced from an external generating plant is mixed with the seawater which is a liquid object to be heated, to transfer heat to the seawater and to thus improve heating efficiency.

EP 513,186 discloses a method of oxidizing materials in the presence of an oxidant and water at supercritical temperatures to obtain useful energy and/or more desirable materials. Pressures between 25 and 220 bars are employed. The use of appropriately high temperatures results in a single fluid phase reactor, rapid reaction rates, high oxidation, and precipitation of inorganic materials.

### SUMMARY OF THE INVENTION

The present invention is an improved thermal evaporation process capable of economically producing fresh water from high saline water, such as seawater. However, the desalination and brine reduction process is applicable to, and adaptable to, freshwater recovery from processed waters, hydrological system (e.g. rivers, lakes, harbor, etc. . . . ) cleaning, treating of oil/gas field services including frac and produced waters, industrial waste waters, municipal waters and the like.

The process employs the use of a multiphase pump and/or large compressor for injection of hot air into a brine stream. A series of mixers, separators and condensers separate the brine steam into concentrated brine, a vapor brine and condensate. A portion of the concentrated brine is discharged and the remainder recycled to obtain conversion efficiencies exceeding 80 percent. A heat exchanger preheats raw brine water and reduces heat directing to a second condenser. The system separates steam and air received from mixers wherein concentrated brine is expelled and brine recycled to the multiphase pump until predetermined design operating conditions are reached for optimum efficiency.

It is an objective of the present invention to provide a new and improved method for desalination of water that eliminates the need for reverse osmosis, distillation, and electrodialysis.

Another objective of the invention is provide a water desalination and brine volume reduction system wherein the total energy input required for the purification of the water is less than electrodialysis, distillation or reverse osmosis treating similar total dissolved solids.

Still another objective of the present invention is to provide a process for the desalination of water by evaporating in which the non-evaporating substances contained in the water can be removed with purity achieved in the vapor to be extracted as condensate.

Another objective of the invention is to employ separators to withdraw moisture-laden air stream from the brine followed by a condenser to condensate the moisture in the air stream to produce fresh water.

Another objective of the invention is to provide a process for the desalination of water by preheating brine water through excess condenser heat.

Still another objective of the invention is to introduce heated air into brine to create a water vapor, wherein the water vapor is cooled to below the specified saturation or dew point temperature of the water vapor for at a particular pressure allowing for evaporation enthalpy.

Another objective of the invention is provide a water desalination and brine volume reduction system wherein the total energy input required for the purification process of the water is less than all currently available alternative processes.

Yet another objective of the invention is provide a method of brine volume reduction or brine concentration which may produce a brine stream of about 10% solids (e.g. semi-crystallizing dense liquid substance).

Still another objective of the invention is provide a desalination and brine reduction is applicable to, and adaptable to, freshwater recovery from processed waters, hydrological system (e.g. rivers, lakes, harbor, etc. . . . ) cleaning, oil/gas field services including frac and produced waters, industrial waste waters, municipal waters and the like.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a schematic view of a preferred embodiment of the multiphase desalination apparatus of this invention;

FIG. 2 is a schematic view of the preferred embodiment depicting mass and energy balances; and

FIG. 3 is a schematic view of an alternative embodiment of the multiphase desalination process.

### DETAILED DESCRIPTION OF THE PREFERRED EMBODIMENT

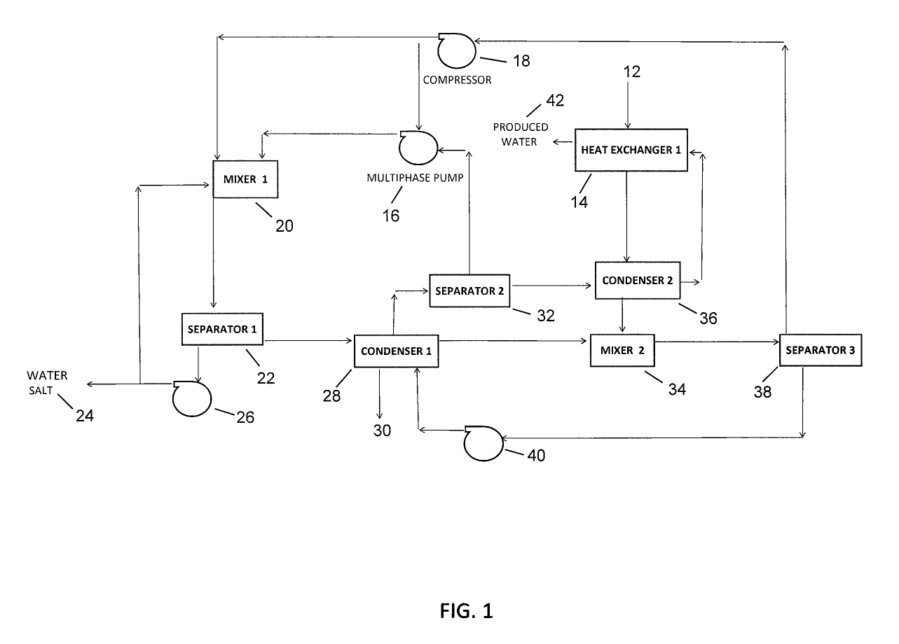

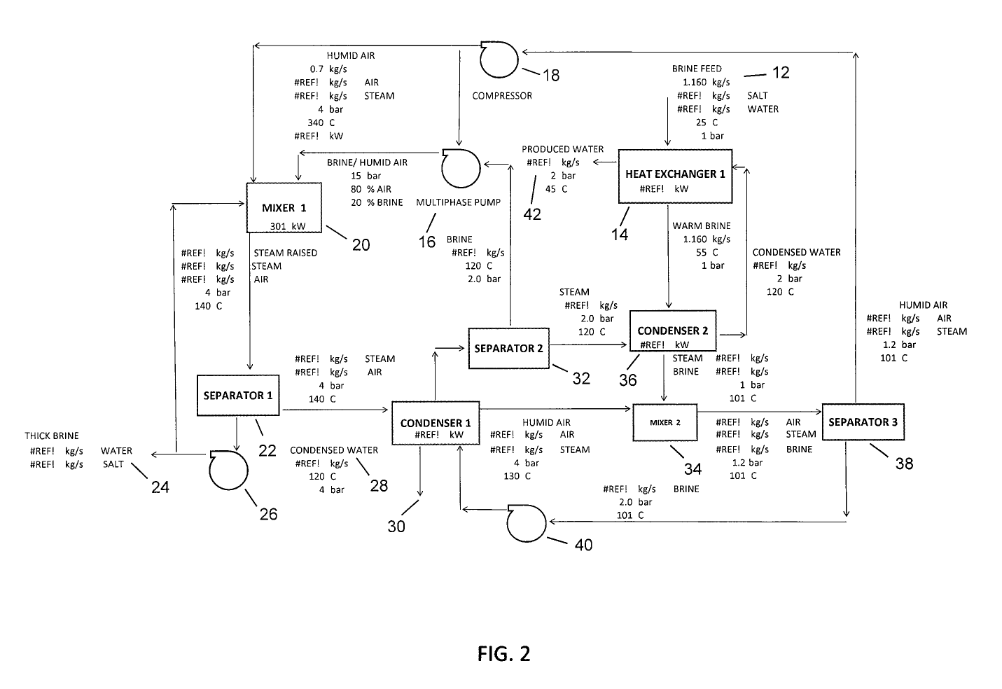

Referring now to figures, FIG. 1 is a simplistic flow diagram of the instant method of water desalination and brine volume reduction and FIG. 2 will further describe the invention by inclusion of a prophetic example illustrating the flow rates, temperature and pressure changes. The system establishes a flow of brine 12 into a heat exchanger 14 for priming of a multiphase pump 16. The multiphase pump 16 is a progressive cavity pump that subjects the fluid mixture to progressively increasing pressures and thus accompanying increasing temperatures, on the order of 20 bars pressure and 200+ degrees Fahrenheit under normal operation. The pump allows for rapid and complete energy transfer to the fluid mixture and the subsequent ability to flash separate the mixture components. A compressor 18 is initiated for injecting hot air into the multiphase pump 16 and a first mixer 20. The brine is now heated and having a humid air flow directed to a first mixer 20. The brine stream is drawn through a first separator 22 forming a flow of concentrated water salt that is recycled to the first mixer 20 by first recycling pump 26. A purge stream removes any build up of salt from the process. The vapor is directed into a first condenser 28 producing fresh water output 30, vapor that is not condensed is directed to a second mixer 34. Brine from pump 40 is used as coolant for first condenser 30. The brine is heated to its boiling point and then partially evaporated using the latent heat of vaporization from the condensing vapor. The brine steam is directed to separator 32. The second separator 32 produces liquid brine for recycling to the multiphase pump 16 and into a steam for introduction into a second condenser 36. Condensed water is directed to a heat exchanger 14. Second condenser 36 uses brine from first heat exchanger 14 as coolant. The brine is heated to its boiling point and partially evaporated. The brine steam is then directed to second mixer 34 which is then combined with the vapor from second separator 32. The resulting pure water is collected by the condenser.

As previously mentioned, raw water 12 is directed into the heat exchanger 14 wherein the heat exchanger 14 conditions the temperature of the fluid introduced into the second condenser 36 which is further drawn into the second mixer 34. Fluid from the second mixer is inserted into a third separator 38 for separating steam and air received from the second mixer 34, separated humid air is recycled to the compressor 18, separated brine is directed to the first condenser 28 by transfer pump 40. Output from heat exchanger includes produced water 42.

In operation, start-up of the compressor and multiphase pump consists of the following steps.
1. Establish flow of fresh brine to multiphase pump 16.
2. Turn on multiphase pump 16.
3. Establish flow of brine to a first Mixer 20.
4. Turn on compressor 18 with partial venting.
5. Establish hot air flow to the first Mixer 20 and to the feed of the Multiphase Pump 16.
6. Monitor the first Mixer 20 exit temperature and pressure.
7. Establish multiphase flow of brine and air to a first Separator 22. The air becomes humidified with the water. Impurities remain in the liquid brine stream.
8. Establish recycle stream of liquid from Separator 1 22 back to a first Mixer 20.
9. Turn on a first Pump 26.
10. Establish the thick brine purge stream 24. This removes the required amount of salt and other impurities.
11. Establish liquid flow from the first Pump 26 back to the first Mixer 20 and to the Multiphase Pump 16.
This starts a hot recycle flow to the Multiphase Pump and aids the warm-up of the multiphase Pump.
12. Reduce flow of fresh brine to the multiphase Pump 16 to maintain a steady flow to the multiphase pump 16.
13. The Multiphase Pump 16 compresses the air/brine mixture and, from the heat of compression, the fluids are heated to about 120 C.
14. The air becomes humidified and saturated with the water vapor.
15. The multiphase mixture from the Multiphase Pump goes to the first Separator 22.
16. The first Separator removes the humidified air and passes it to the first Condenser 28.
17. The liquid stream is let down to 4 bars and fed to the first Mixer 20.
18. In start-up, all or the air/steam is vented to atmosphere after passing to a third Separator 38.
19. Continue to recycle to the Multiphase Pump until Design Operating Conditions are reached.

Start-up of the condensers and water production consists of the following steps:
1. Establish fresh brine feed to the first Condenser 28 to provide the coolant.
2. Establish the liquid flow to second Mixer 34.
3. Bring the second Mixer 34 online and establish the multiphase flow to the third Separator 38.
The mixer lets down the pressure of the incoming air/steam stream from the first Condenser 20 from 4 bars to 1 bar and it forced through the fresh brine. This humidifies and saturates the air stream with more water vapor.
4. Bring online the third Separator 38 and turn on a second Pump 40.
5. Increase pressure of liquid stream to 4 bars and monitor pressure and temperature of feed to the Heat Exchanger 14.
6. Establish flow of brine to the Heat Exchanger 14 to provide coolant.
7. The Heat Exchanger 14 cools the hot water stream from the first Condenser 28 and captures more waste heat energy.
8. The brine is heated from about 45 C to 95 C before being fed to the first Condenser 28 to provide the coolant for the condensation of the water from the air/steam stream.
9. The air and steam from the first Separator 22 is let down from 15 bars to 4 bars and mixed with the air/steam from Separator 1 and then passed into the first Condenser 28 where it is cooled to 120 C. The saturated air stream gives up most of the water vapor as condensation.
10. The condensed water is then fed to the Heat Exchanger where it is cooled to provide the pre-heat for the fresh brine.
11. The exiting air/steam stream is passed to a second Mixer 34 to provide the air for bubbling into the fresh brine in the second Mixer 34.
12. The heat obtained from condensing the water in the first Condenser 20 is used to heat the fresh brine stream to its boiling point at 100 C and then evaporate some of the water from the fresh brine.
13. The brine/steam mixture is passed to the second Separator 32 where the liquid at 100 C is fed to the Multiphase Pump 16.
14. The steam is passed to the second Condenser 36 where it is condensed using the fresh brine feed at 25 C.
15. At start-up, the hot humidified air stream from the third Separator 38 is vented to atmosphere.
16. At the end of start-up, when everything is at the designed operating conditions, the vent after the third Separator 38 is closed and the hot humidified air stream is fed to the Multiphase Pump. This completes the energy recovery of any waste heat and any uncondensed water vapor in the air stream.
17. The feed rates to the Compressor 18 and Multiphase Pump 16 are steadily increased to the full flow rates.

### EXAMPLE

| 100,000 kg/day, brine at 3.5% salt (3.5% weight) | |
|---|---|
| 1.16 kg/s brine feed | |
| .902 kg/s water produced | |
| 78% recovery | |
| Data: heat capacity of water | 4.2 kj/kg C. |
| Heat capacity of brine | 3.8 kj/kg C. |
| Heat capacity of steam | 1.8 kj/kg C. |
| Heat capacity of air | 1.0 kj/kg C. |
| Latent Heat of Vaporization | 2258 kj/kg at 1 bar 100 C. |
| | 2244 kj/kg at 1.2 bar 105 C. |
| | 2202 kj/kg at 2 bar 120 C. |
| | 2133 kj/kg at 4 bar 144 C. |
| | 1945 kj/kg at 15 bar 198 C. |
| Vapor pressure of steam | 788 mm HG 101 C. |

The system establishes a flow of brine of 1.160 kg/s at 1 bar and 25 C into a heat exchanger 14. The multiphase pump 16 and compressor 18 is initiated for injecting hot air into the multiphase pump 16 and a first mixer 20 of 0.7 kg/s at 4 bar and 340 C. The multiphase pump output is 20% brine, 80% air at 15 bar. The brine now heated having a humid air flow is directed to a first mixer 22 with steam raised and drawn through a first separator 22 forming a flow of concentrated thick brine 24 that is discharged and the remainder recycled to the first mixer 20 by first recycling pump 26 at 4 bar and 140 C. The vapor brine from the first separator 22 is directed into a first condenser 28 producing condensed water output 30, vapor brine that is not condensed is directed to a second separator 32 and a second mixer 34, the humid air is at 4 bar 130 C. The second separator produces a liquid brine at 2 bar 120 C for input to the multiphase pump 16 and into a steam at 2 bar 120 C for introduction into a second condenser 36. Condensed water at 2 bar 120 C is directed to heat exchanger 14 and non condensed steam brine at 1 bar 101 C is transferred to the second mixer 34. Raw water 12 is directed into the heat exchanger 14 wherein the heat exchanger 14 lowers the temperature of the condensed water introduced by the second condenser 36. Fluid from the second mixer 34 at 1.2 bar 101 C is inserted into a third separator 38 for separating steam and air received from the second mixer 34, separated humid air of 1.2 bar 101 C is recycled to the compressor 18, separated brine at 2 bar 101 C is directed to the first condenser 28 by transfer pump 40. Output from heat exchanger includes produced water 42 at 2 bar 45 C.

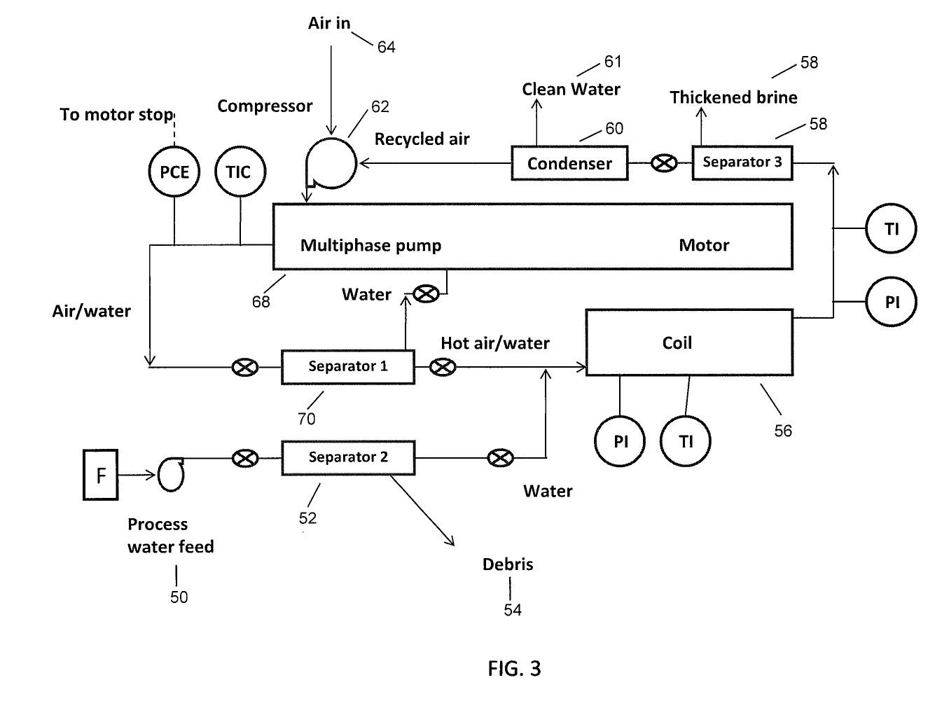

FIG. 3 is a further schematic of the system illustrating a variation of the process wherein the process begins using a pump 50 directing fluid to a separator 52 for removal of debris 54. The fluid is then directed into the coil 56. Separator 58 draws thickened brine with the fluid introduced into a condenser 60 for removal of clean water 61. The remaining fluid is drawn into a compressor 62 with air induction 64 for entry into the multiphase pump 68. The pump is a progressive cavity pump that subjects the fluid to progressively increasing pressures and thus accompanying increasing temperatures, on the order of 20 bars pressure and 200+ degrees Fahrenheit under normal operation. The compressor is initiated for injecting hot air into the multiphase pump wherein the fluid is now heated and having a humid air flow directed to into the separator 70, a portion of which is recirculated into the pump 68 and the remainder directed into the coil 56 with the water from the separator 52 added to the blend. The resulting recovery rate is above 80 percent of the brine water to desalinated water. The benefit allows for the collection of less water compared to conventional known desalination plants to generate the same volume of desalinated water. The increased recovery translates to proportionally smaller footprint size and cost of facilities. Further, it is noted that the system does not require any pretreatment.

### Principles of Operation

a) Atmospheric air is mixed with warm, humid recycled air and passed to compressor;

b) Air is compressed to 50-60 psia and resulting air is at 500-600 F;

c) The hot air and recycled hot water are mixed and fed to multiphase pump at ratio of 80-90% air to 20-10% water and 50-60 psia;

d) Multiphase pump them compresses the air/water mixture to 230-340 psia;

e) The heat of compression of the air increases the mixture temperature and humidifies the air to saturation. The exit temperature is maintained at 200-210 F at 230-240 psia, there is still liquid water present;

f) Some of the hot water is separated from the mixture using the centrifugal separator #2 and recycled to mix with the incoming air;

g) The remaining humid air and hot water is mixed with more fresh, warm seawater and passed to the coil;

h) The pressure is let down to 30-45 psia in the coil. The air accelerates and completely contacts and mixes with the water. The air is saturated with water vapor;

i) Some of the water flashes to steam and the latent heat is recovered and is used to heat the fresh incoming seawater. The exit temperature is 180-200 F;

j) The ensuing mixture or humid air, salt residue is passed to centrifugal separator #3 where the most of the humid air is taken off;

k) The salt residue is collected;

l) The humid air is passed to the condenser which is cooled by incoming seawater and the water condenses out. The exiting water temperature can be controlled by the flowrate of incoming seawater or by adding a secondary cooler also cooled by incoming seawater; and

m) The warm air is available for mixing with fresh incoming air before being fed to the compressor.

### Pre-Treatment of the Seawater

a) The pre-filtered seawater is pumped using a progressing cavity pump into separator #1 to remove any small solids/debris;

b) The seawater is then passed into the cooler used to trim the outgoing drinking water and then into the condenser to condense out the water; and

c) The warm water is then injected into the coil to mix with the hot, humid air and pressurized hot water.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of water desalination and brine volume reduction comprising:
establishing a flow of brine to a multiphase pump, said multiphase pump subjecting said flow of brine to progressively increasing pressures and increasing temperatures;
initiate a compressor with partial venting and injecting hot air into said multiphase pump;
directing a brine fluid and humid air flow from said multiphase pump to a first mixer;
introducing hot air into said first mixer to form a fluid flow of brine air steam;
separating said brine vapor into a thick brine and a vapor by a first separator, a portion of said thick brine is discharged and the remainder recycled to said first mixer;
condensing said vapor from said first separator and drawing condensed fresh water therefrom, vapor that is not condensed is directed to a second separator and a second mixer;
separating said vapor brine that is not condensed by said first condenser into a liquid brine for recycling to said multiphase pump and to a steam for introduction into a second condenser;
condensing said steam from said second separator wherein condensed water is directed to a heat exchanger and non condensed water is transferred to said second mixer;
inputting into said heat exchanger a raw water brine feed, said heat exchanger lowering the temperature of said second condenser and for produced water;
combining steam and brine from said second condenser and directing to said second mixer for combining with humid air from said first condenser;
separating steam and air received from said second mixer by use of a third separator, separated humid air recycled to said compressor, separated brine recycled to said first condenser;
wherein said thick brine is expelled and brine recycled to said multiphase pump until predetermined design operating conditions are reached.

2. The method of water desalination according to claim 1 wherein said fresh brine feed to said second condenser acts a coolant and said second mixer lowers the pressure of the incoming air/steam stream from said first condenser from 4 bars to 1 bar and it forced through the fresh brine to humidify and saturate the air stream with more water vapor.

3. The method of water desalination according to claim 1 wherein said heat exchanger captures waste heat energy.

4. The method of water desalination according to claim 1 wherein said brine is heated from about 45 C to 95 C before being fed to said first Condenser to provide the coolant for the condensation of the water from the air/steam stream.

5. The method of water desalination according to claim 1 wherein said air and steam from said first is reduced from about 15 bars to about 4 bars and passed into said first condenser where it is cooled to 120 C whereby the saturated air stream gives up most of the water vapor as condensation.

6. The method of water desalination according to claim 1 wherein said heat obtained from condensing the water in said first Condenser is used to heat the fresh brine stream to its boiling point at 100 C and then evaporate some of the water from the fresh brine.

7. The method of water desalination according to claim 1 wherein said steam is passed to said second Condenser 2 where it is condensed using the fresh brine feed at 25 C.

8. The method of water desalination according to claim 1 wherein the hot humidified air stream from said third separator is vented to atmosphere during start-up.

9. The method of water desalination according to claim 1 wherein the hot humidified air stream is fed to the multiphase pump after start-up allowing energy recovery of any waste heat and uncondensed water vapor from the air stream.

10. The method of water desalination according to claim 1 wherein the feed rates to the compressor and multiphase pump are steadily increased to reach full flow rates.

11. The method of water desalination according to claim 1 wherein said multiphase pump compresses the air/brine mixture.

12. The method of water desalination according to claim 1 wherein said compressor produces heated air above 300° C.

13. The method of water desalination according to claim 1 wherein said liquid flow from said separator includes a first pump for transferring said thick brine and said first mixer recycle fluid.

14. The method of water desalination according to claim 1 including the step of adjusting the flow of fresh brine to said multiphase pump to maintain a steady flow wherein the air becomes humidified and saturated with water vapor.

15. The method of water desalination according to claim 1 including the step of reducing steam pressure from said second separator and directing said steam to said second condenser.

16. The method of water desalination according to claim 1 wherein said multiphase pump is a progressive cavity pump.

17. The method of water desalination according to claim wherein said progressive cavity pump subjects the fluid mixture to progressively increasing pressures on the order of 20 bars and increasing temperatures on the order of 200+ degrees Fahrenheit.
